(19) United States
(12) Patent Application Publication
(10) Pub. No.: US 2012/0108282 A1
(43) Pub. Date: May 3, 2012

(54) METHODS AND APPARATUS FOR POWER CONTROL AND INTERFERENCE MANAGEMENT IN WIRELESS MICROPHONE TRANSMISSION SYSTEMS

(75) Inventors: Junyi Li, Chester, NJ (US); Mathew Scott Corson, Gillette, NJ (US); Thomas J. Richardson, South Orange, NJ (US); Frank A. Lane, Easton, PA (US)

(73) Assignee: QUALCOMM Incorporated, San Diego, CA (US)

(21) Appl. No.: 13/217,194

(22) Filed: Aug. 24, 2011

Related U.S. Application Data
(60) Provisional application No. 61/376,803, filed on Aug. 25, 2010.

(51) Int. Cl. H04W 72/04; H04W 52/24; H04W 52/20

(52) U.S. Cl. 455/509; 455/522

(57) ABSTRACT

A wireless microphone receiver is used to control transmission power and/or channel configuration of wireless microphones which communicate audio data to the wireless microphone receiver. In some embodiments the wireless microphone receiver searches for available channels, e.g., on a periodic or other basis. Based on wireless microphone receiver loading and interference considerations, channel availability may be determined and channel assignments are made. In some embodiments channel assignments are made based on wireless microphone battery status. Channel assignments to wireless microphones are communicated via a control channel. In addition to channel assignments, wireless microphone transmitter power can be controlled by the wireless microphone receiver. Commands to increase or decrease transmission power may occur as channel conditions change and/or on a recurring periodic basis. The rate of power control transmission may be relatively infrequent, e.g., a second apart in some embodiments, given that wireless microphones tend to be relatively stationary during use.

### RELATED APPLICATIONS

This application claims the benefit of U.S. Provisional Patent Application Ser. No. 61/376,803, filed Aug. 25, 2010, titled “Wireless Microphone Apparatuses and Methods” which is hereby expressly incorporated by reference in its entirety.

### FIELD

Various embodiments relate to wireless communications, and more particularly, to methods and apparatus for power control and interference management in a wireless microphone communications system.

### BACKGROUND

Wireless microphone systems use spectrum which is limited in terms of the amount of spectrum which is available. Accordingly, to support multiple wireless microphones in a given area, interference management can be important.

In the case of wireless microphones, the presence of other microphones and/or devices in an area may make one or more channels, e.g., frequencies, unavailable for use in a given local area. The availability of channels in an area may vary with time as devices move into and out of an area.

Thus, unlike conventional licensed spectrum such as that used by cell phones where the spectrum is tightly regulated and can be used in a predictable manner by a base station, what channels are available in a given area for wireless microphone use may vary with time based on a wide number of factors including the presence of other wireless microphones and wireless microphone receivers in the area. Channels available for use by a wireless receiver and wireless microphones is more likely to be available for use to a nearby wireless receiver if power control of wireless microphone transmissions is implemented.

In current wireless microphone systems, channel assignments and transmission power setting are often made manually, e.g., a wireless microphone receiver and wireless microphone transmitter may be set to use a particular channel. Similarly, a wireless microphone may be manual configured to use one of a plurality of predetermined transmission power levels.

The manual configuration required in many existing wireless microphone systems currently in use results in relatively fixed channel and power settings. As a wireless microphone moves relatively to the wireless microphone receiver, transmission power level requirements may change but the transmission power level may remain fixed due to the failure to manually change the setting. Similarly, while in use channel conditions might change. However, due to the work associated with having to manually reconfigure a wireless microphone transmitter and the possibility of interrupting communication during use, changes in wireless microphone channels may not occur in a timely manner resulting in poor system performance.

In view of the above discussion, it should be appreciated that there is a need for improved methods and apparatus for controlling wireless microphone channel assignments and/or for controlling wireless microphone transmission power levels.

### SUMMARY

Wireless microphone receivers are used to automatically control transmission power and channel configuration of wireless microphones which communicate audio data to the wireless microphone receiver.

In some embodiments the wireless microphone receiver searches for available channels, e.g., on a periodic or other basis. Channel assignments to wireless microphones are communicated via a control channel. A wireless microphone receiving a channel assignment signal responds by switching to the channel assigned by the wireless microphone with the wireless microphone receiver updating its channel to wireless microphone mapping information in a manner that is synchronized to correspond to the switch. Thus, a wireless microphone receiver can seamlessly control microphones to switch between channels without the need for manual configuration and without interfering with the receipt of audio signals from the wireless microphones.

Thus, based on wireless microphone receiver loading and interference considerations, channel availability may be determined and channel assignments can be made. In some embodiments channel assignments are made based on wireless microphone battery status with microphone transmitter devices with less remaining power being assigned communications channels with less interference and thus requiring less transmission power for successful communication with the wireless microphone receiver. Battery status information may be, and in some embodiments is, communicated to the wireless microphone receiver over a control channel.

In addition to channel assignments, wireless microphone transmitter power can be controlled by the wireless microphone receiver. Commands to increase or decrease transmission power may occur as channel conditions change and/or on a recurring periodic basis. The rate of power control transmission may be relatively infrequent, e.g., a second apart in some embodiments, given that wireless microphones tend to be relatively stationary during use compared to other devices such as cell phones which may be subjected to a fair amount of mobility.

In view of the above discussion, it should be appreciated that through the use of a control channel and various control signals from a wireless microphone receiver, manual configuration and settings of channels and/or transmission power levels of wireless microphones can be reduced and/or avoided altogether.

An exemplary method of operating a wireless microphone receiver, in accordance with some embodiments, comprises: scanning a frequency band to be used for wireless microphone communications to detect available communications channels, said available communications channels including a first communications channel; and transmitting a channel assignment signal to a first wireless microphone assigning the first communications channel to said first wireless microphone. An exemplary wireless microphone receiver, in accordance with some embodiments, comprises: at least one processor configured to: scan a frequency band to be used for wireless microphone communications to detect available communications channels, said available communications channels including a first communications channel; and transmit a channel assignment signal to a first wireless microphone assigning the first communications channel to said first wireless microphone. The exemplary wireless microphone receiver further comprises a memory coupled to the at least one processor.

A exemplary method of operating a wireless microphone receiver, in accordance with some embodiments, comprises: transmitting a unicast power control command to a first wireless microphone, said power control command controlling a transmit power of said first wireless microphone; and receiving audio data from the first wireless microphone, said audio data being transmitted at a power level determined from said power control command. An exemplary wireless microphone receiver, in accordance with some embodiments, comprises: at least one processor configured to: transmit a unicast power control command to a first wireless microphone, said power control command controlling a transmit power of said first wireless microphone; and receive audio data from the first wireless microphone, said audio data being transmitted at a power level determined from said power control command. The exemplary wireless microphone receiver further comprises a memory coupled to the at least one processor.

While various embodiments have been discussed in the summary above, it should be appreciated that not necessarily all embodiments include the same features and some of the features described above are not necessary but can be desirable in some embodiments. Numerous additional features, embodiments and benefits of various embodiments are discussed in the detailed description which follows.

### BRIEF DESCRIPTION OF THE FIGURES

FIG. 1 illustrates an exemplary wireless microphone communications system, in accordance with an exemplary embodiment.

FIG. 2 illustrates an exemplary time frequency structure of channels in accordance with one exemplary embodiment.

FIG. 3A is a first part of flowchart of an exemplary method of operating a wireless microphone receiver, in accordance with an exemplary embodiment.

FIG. 3B is a second part of flowchart of an exemplary method of operating a wireless microphone receiver, in accordance with an exemplary embodiment.

FIG. 4A is a first part of a flowchart of an exemplary method of operating a wireless microphone receiver, in accordance with an exemplary embodiment.

FIG. 4B is a second part of a flowchart of an exemplary method of operating a wireless microphone receiver, in accordance with an exemplary embodiment.

FIG. 5 is an exemplary wireless microphone receiver device in accordance with an exemplary embodiment.

FIG. 6 is an assembly of modules which may be used in the exemplary wireless microphone receiver device of FIG. 5 in some embodiments.

FIG. 7 is another assembly of modules which may be used in the exemplary wireless microphone receiver device of FIG. 5 in some embodiments.

FIG. 8 is a table illustrating exemplary channel selection rules for assigning a communications channel to a wireless microphone, in accordance with some exemplary embodiments.

### DETAILED DESCRIPTION

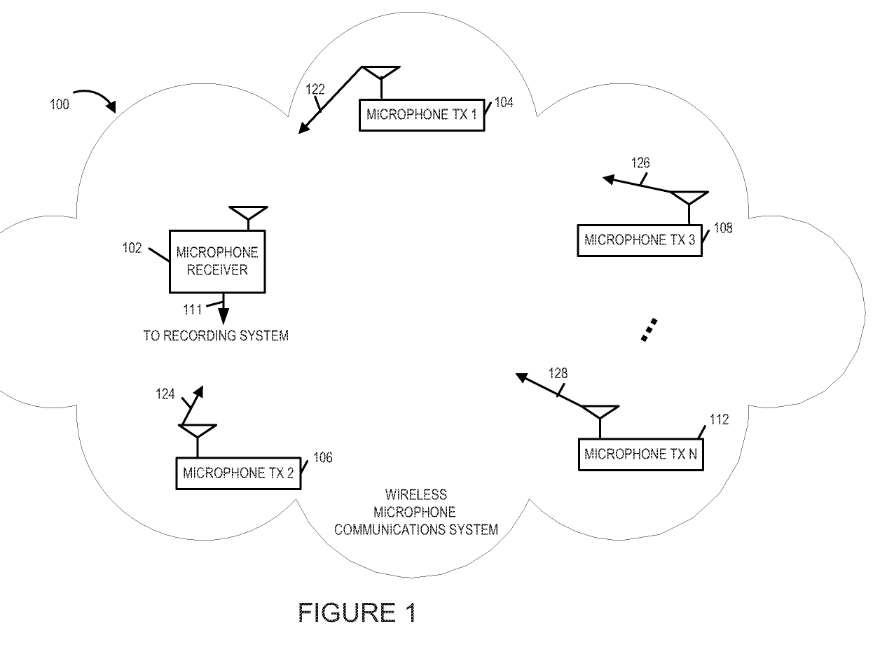

FIG. 1 is a drawing of an exemplary wireless microphone system 100, in accordance with an exemplary embodiment. Exemplary wireless microphone system 100 includes a plurality of wireless microphone devices, e.g., wireless microphone receivers and wireless microphone transmitters. Wireless microphone transmitters are sometimes simply referred to as wireless microphones. In the exemplary system 100 illustrated in FIG. 1, a single wireless microphone receiver 102 is shown serving a plurality of wireless microphone transmitters including wireless microphone transmitters 104, 106, 108, . . . , and 112. Although a single wireless microphone receiver 102 is shown, it should be appreciated that multiple microphone receivers may, and in some embodiments are, used in the system and may be located at different locations. Wireless microphones in system 100 transmit and/or receive signals, e.g., audio signals, control signals, feedback signals etc., to and/or from the wireless microphone receiver 102. The wireless microphone receiver 102 communicates with various wireless microphone transmitters in the system, e.g., via a wireless link. The wireless microphone receiver 102 provides access to a recording system and/or other network resources, via a wired or fiber network connection 111.

In accordance with one feature, wireless microphone receiver 102 receives channel assignment requests 122, 124, 126, . . . , 128 from one or more wireless microphone transmitters in the system, e.g., microphone transmitters 104, 106, 108, . . . , 112. The wireless microphone receiver 102 scans a frequency band to detect available communications channels which can be used for microphone communications and assigns communications channels to the one or more wireless microphone devices that requested channel assignment. The wireless microphones 104, 106, 108, . . . , and 112 use their assigned communications channel for, e.g., audio traffic transmissions. In various embodiments the wireless microphone receiver 102 takes into consideration one or more factors including, e.g., channel conditions of one or more available channels, and battery status of wireless microphones requesting channel assignment, in making channel assignment decisions.

In accordance with one feature of some embodiments the wireless microphone receiver 102 controls the transmit power which is used by wireless microphone transmitters for communicating data traffic to the wireless microphone receiver 102. In some embodiments the microphone receiver 102 transmits power control commands to the wireless microphones 104, 106, 108, . . . , and 112 to increase or decrease transmission power as channel conditions, corresponding to the channel used by the respective microphones, change over time. In some embodiments the wireless microphones 104, 106, 108, . . . , and 112 monitor for control signals from the wireless microphone receiver 102 during predetermined time intervals.

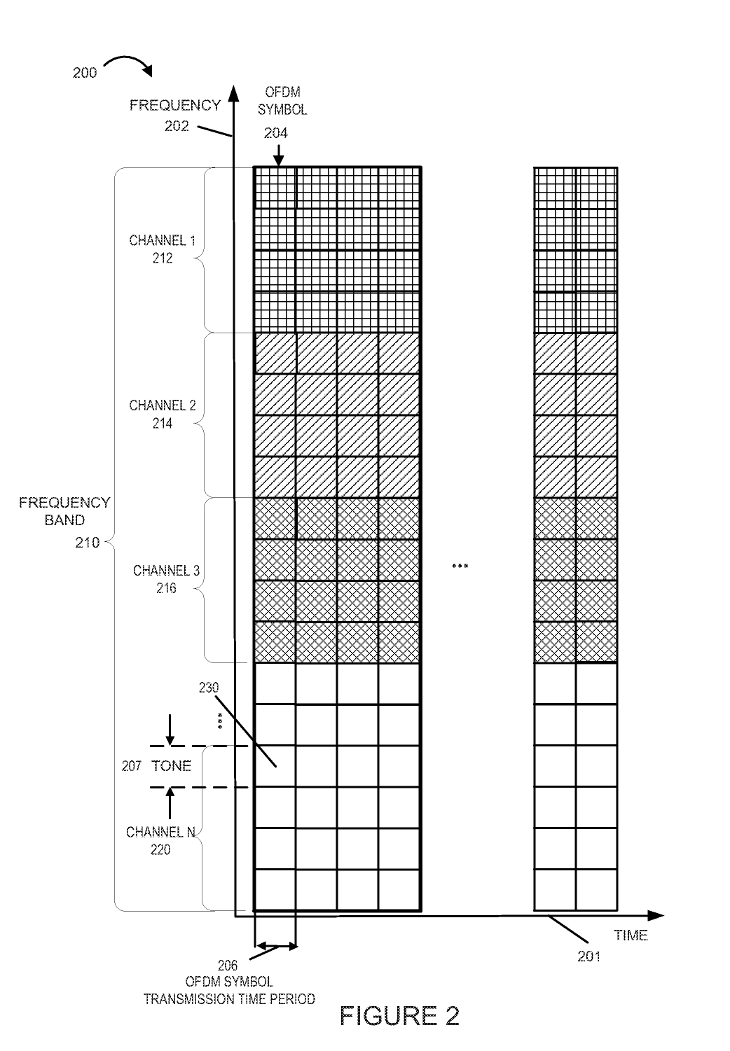

FIG. 2 is a drawing 200 illustrating an exemplary frequency band 210 and communications channels 212 through 220, which can be used for wireless microphone communications, in accordance with some exemplary embodiments. FIG. 2 shows the time frequency structure of exemplary communications channels which can be used for microphone communications. Consider an exemplary embodiment of a frequency division multiplexing system, e.g., an OFDM system. In one such embodiment during a symbol transmission period, available bandwidth (frequency) is divided into a number of tones, each of which can be used to carry information, e.g., communicated by a microphone signal.

In FIG. 2, the horizontal axis 201 represents time and the vertical axis 202 represents frequency, e.g., a frequency band. A vertical column represents an OFDM symbol, e.g., OFDM symbol 204, having a duration corresponding to one symbol transmission time period 206. An exemplary single tone 207 is illustrated. Each of the OFDM symbols includes multiple tones (frequencies) corresponding to a given symbol transmission time period. The OFDM symbol transmission time period identified by reference number corresponds to the time used to transmit one OFDM symbol. Each small box 230 represents a tone-symbol, which is the air link resource of a single tone over a symbol transmission time period. Each of the individual tone-symbols 230 is a communications resource and has a frequency and time period associated with it as should be appreciated from the figure.

As can be appreciated from the figure, the frequency band 210 can be divided into a plurality of communications channels including channel 1 212, channel 2 214, channel 3 216, . . . , channel N 220 etc. Each communications channel may include one or more tones. In the example of FIG. 2 the frequency band 210 is a 6 MHz band and each channel includes, e.g., 16 OFDM tones.

Wireless microphones 104, 106, . . . , 112, communicate with the microphone receiver 102, e.g., transmit audio signals, using an assigned communications channel. In accordance with one aspect of various embodiments, the wireless microphone receiver 102 performs a scanning operation scanning one or more frequency bands, e.g., frequency band 210, to detect available communications channels which can be used for microphone communications. In various embodiments the frequency band 210 is available for use not only by various microphone devices but for television broadcasts as well. In various embodiments the wireless microphone receiver 102 also determines channel conditions/interference on the detected communications channels to select, e.g., a relatively interference free communications channel, to be assigned to a wireless microphone seeking channel assignment for microphone communications. The channel conditions may change over time and one or more channels which are not detected to be available at one point in time may become available at some later point in time. In some embodiments the wireless microphone receiver repeats the scanning operation periodically and may reassign a better channel quality communications channel to a wireless microphone which had been previously assigned a communications channel, when the better quality channel becomes available. For example, the first channel 212 may be assigned to the first wireless microphone 104 at some point in time, however during subsequent scanning of the frequency band 210 it is determined that the second channel 214, e.g., having a better channel quality than the channel quality of the first channel 212 by at least a predetermined amount, is available. In such a scenario the wireless microphone receiver 102 may decide to reassign the second channel 214 to the first wireless microphone, provided one or more predetermined conditions are satisfied.

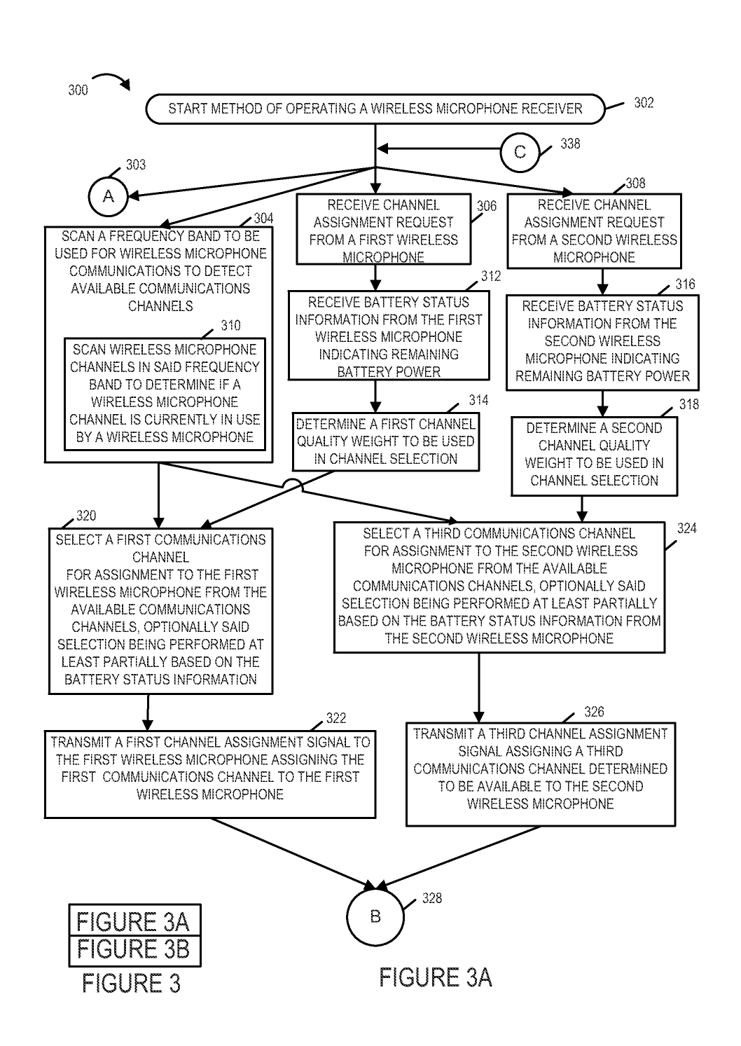

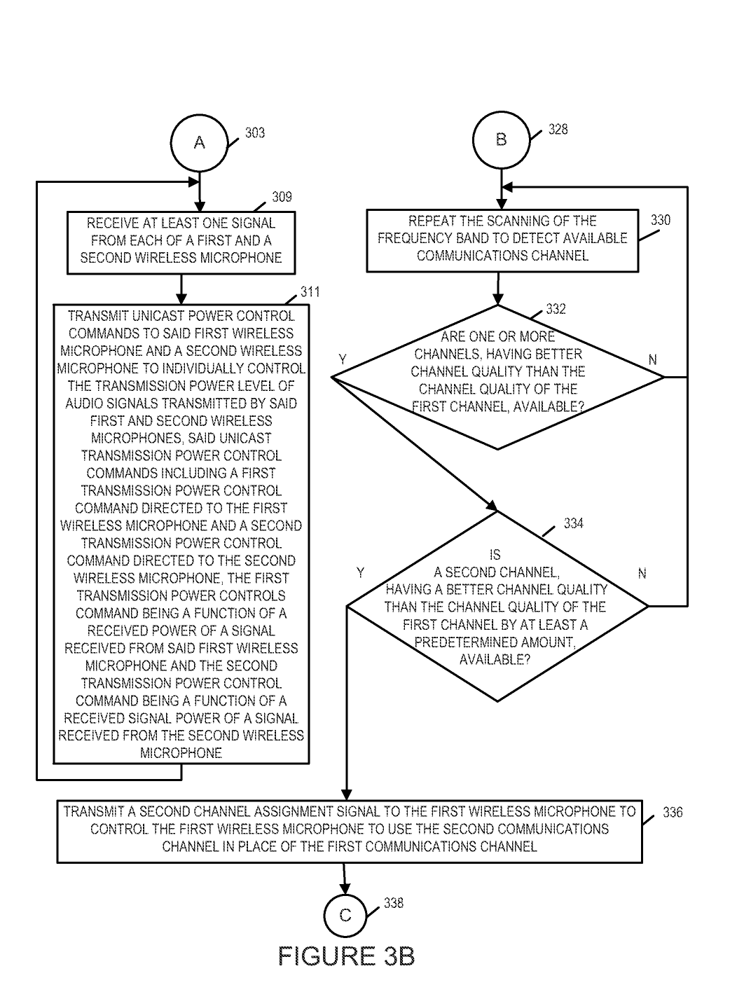

FIG. 3, which comprises a combination of FIGS. 3A and 3B, illustrates a flowchart 300 of an exemplary method of operating a wireless microphone receiver, in accordance with an exemplary embodiment. The wireless microphone receiver implementing the method of flowchart 300 is, e.g., wireless microphone receiver 102 of system 100 of FIG. 1. As will be discussed, in accordance with one feature of various embodiments, the wireless microphone receiver 102 scans one or more frequency bands including channels which can be used for wireless microphone communications, to detect available channels for assignment to wireless microphones. A given wireless microphone uses the microphone receiver 102 assigned communications channel for microphone communications.

The method of flowchart 300 shown in FIG. 3 starts in step 302, where the wireless microphone receiver 102 is powered on and initialized. Operation proceeds from start step 302 to steps 304, 306, 308 and, via connecting node A 303, to step 309 Steps 304, 306, 308 and 309 may be, and in some embodiments are, performed in parallel.

In step 304 the wireless microphone receiver 102 scans a frequency band, e.g., frequency band 210, to be used for wireless microphone communications to detect available communications channels, the available communications channels including a first communications channel, e.g., channel 1 212. In various embodiments performing a scanning operation on the frequency band includes performing step 310 as part of performing step 304. In step 310 the wireless microphone receiver 102 scans wireless microphone channels in the frequency band 210 to determine if a wireless microphone channel is currently in use by a wireless microphone. It should be appreciated that the frequency band 210 may include channels other than wireless microphone channels, which may be used for other types of communications. Thus as part of the scanning operation, the wireless microphone receiver 102 scans the wireless microphone channels to detect if the wireless microphone channels in the band 210 are in use by other wireless microphones.

In various embodiments scanning operation is performed to detect available communications channels and/or determine channel conditions, e.g., interference levels, of the available communications channels. The detection operation may be performed in variety of ways, e.g., by performing channel sensing on various wireless microphone channels to detect energy on the time-frequency resources corresponding to the wireless microphone channels. For example, the wireless microphone receiver 102 performs channel sensing and examines each wireless microphone channel to detect signals. One or more microphone channels on which no signals above, e.g., a threshold, are detected may be considered as being available for use. If the signals detected on a microphone channel are above the threshold, it may be considered as being already occupied, e.g., used by another wireless microphone. The operation proceeds from step 304 (including step 310) to steps 320 and 324.

Returning to step 306, in step 306 the wireless microphone receiver 102 receives a channel assignment request from a first wireless microphone, e.g., wireless microphone 1 104. The channel assignment request is a request to assign a communications channel for wireless microphone communications. Operation proceeds from step 306 to step 312. In step 312 the microphone receiver 102 receives battery status information from the first wireless microphone 1 104 indicating the remaining battery power of the first wireless microphone 104. As will be discussed, in accordance with one aspect of some embodiments, the wireless microphone receiver 102 uses the battery status information corresponding to a given wireless microphone in making a channel assignment decision for the given wireless microphone. The operation proceeds from step 312 to step 314 where the wireless microphone receiver 102 determines a first channel quality weight to be used in a channel selection process for assigning a channel to the first wireless microphone 1 104. The channel quality weight to be used in selecting a channel to be assigned to the first wireless microphone 104 is determined based on the battery status information received from the first wireless microphone 104. In various embodiments, a higher channel quality weight is selected for a wireless microphone with lower battery power while a lower channel quality weight may be selected for microphones with higher remaining battery power. The microphones with lower remaining batter power may be assigned communications channel with good channel quality, e.g., with less interference levels, so that they require less transmission power for communications with the microphone receiver 102. In some embodiments the wireless microphone receiver 102 generates and maintains a log including information indicating the channel quality of a plurality available communications channels detected in the scanning operation, and battery status information indicating remaining batter power of different wireless microphone. The channel conditions and interference may change over time and thus the information indicating the channel quality of the available channels is updated, e.g., periodically. Operation proceeds from step 314 to step 320.

Returning now to step 320. In step 320 a first communications channel, e.g., channel 212, is selected for assignment to the first wireless microphone 104 from the available communications channels. It should be noted that the first channel quality weight (determined in step 314) is also an input to step 320 and in some embodiments the selection of the first communications channel for assignment to the first wireless microphone is performed at least partially based on the first channel quality weight and the battery status information. In some embodiments the selection of a channel for channel assignment to the first wireless microphone 104 is based on said battery status information and information indicating channel quality of a plurality of available communications channels.

Operation proceeds from step 320 to step 322. In step 322 the wireless microphone receiver 102 transmits a first channel assignment signal to the first wireless microphone assigning the first communications channel 212 to the first wireless microphone 104. In some embodiments the first communications channel 212 is a wireless microphone channel on which no wireless microphone signals were detected by the scanning performed in step 304. The operation proceeds from step 322 to step 330 via connecting node B 328.

Returning to step 308, in step 308 the wireless microphone receiver 102 receives a channel assignment request from a second wireless microphone, e.g., wireless microphone 2 106 of system 100 of FIG. 1. Operation proceeds from step 308 to step 316. In step 316 the microphone receiver 102 receives battery status information from the second wireless microphone 2 106 indicating the remaining battery power of the wireless microphone 106. The operation proceeds from step 316 to step 318 where the wireless microphone receiver 102 determines a second channel quality weight to be used in a channel selection process for assigning a channel to the second wireless microphone 106. The second channel quality weight to be used in selecting a channel to be assigned to the second wireless microphone 106 is determined based on the battery status information received from the second wireless microphone 106. It should be appreciated that steps 308, 316 and 318 relate to processing performed for a second wireless microphone and are similar to steps 306, 316 and 314 which relate to processing performed for the first wireless microphone. The operation proceeds from step 318 to step 324.

In step 324 a third communications channel, e.g., e.g., channel 216, is selected for assignment to the second wireless microphone 106 from the available communications channels. The second channel quality weight (determined in step 318) is also an input to step 324 and in some embodiments the selection of the third communications channel for assignment to the second wireless microphone 106 is performed at least partially based on the second channel quality weight and the battery status information received from the second wireless microphone 106.

Operation proceeds from step 324 to step 326. In step 326 the wireless microphone receiver 102 transmits a second channel assignment signal to the second wireless microphone 106, assigning the third communications channel 216 to the second wireless microphone 106. In some embodiments the third communications channel 216 is a wireless microphone channel on which no wireless microphone signals were detected by the scanning performed in step 304. The operation proceeds from step 326 to step 330 via connecting node 328.

In step 330 the wireless microphone receiver 102 repeats the scanning operation of the frequency band (as done in step 304) to detect available communications channels and/or to detect interference/noise conditions on one or more channels which were detected in the previous scanning operation. The scanning operation may be repeated, e.g., on a periodic basis. As channel conditions change over time due to ongoing communications from nearby microphone devices, it is possible that one or more channels which may have not been detected to be available earlier, may become available at a later time. Thus repeating the scanning operation allows for detection of, e.g., newer channels which were previously not detected to be available. Repeating the scanning operation also allows for determining current channel conditions on one or more available communications channels.

Operation proceeds from step 330 to step 332. In some embodiments steps 332 and 334 may be performed as part of step 330. In step 332 it is determined if one or more channels, having a better channel quality than the channel quality of the first channel 212, have been detected to be available. If it is determined that one or more channels having a better channel quality than the channel quality of the first channel 212 are available, then operation proceeds from step 332 to step 334; otherwise, the operation proceeds from step 332 back to step 330 for additional scanning

In step 334 the wireless microphone receiver 102 determines if a second channel, having a better channel quality than the channel quality of the first channel 212 by at least a predetermined amount, is available. Thus following the determination that one or more channels having better channel quality than the first channel 212 are available, the microphone receiver 102 determines if the channel quality of at least one channel from the available better quality channels, is better than the channel quality of the first channel 212 by at least a predetermined amount. If it is determined that a channel, e.g., second channel 214, having a better channel quality than the first channel quality by a predetermined amount is available, the operation proceeds to step 336. However if no such channel is detected where the corresponding channel quality is better than the channel quality of the first channel 212 by at least the predetermined amount, then the operation proceeds from step 334 back to step 330.

In step 336 the wireless microphone receiver 102 transmits a second channel assignment signal to the first wireless microphone 104 to control the first wireless microphone 104 to use the second communications channel 214 in place of the first communications channel, the second channel 214 having a better channel quality than the channel quality of the first communications channel by at least a predetermined amount. It should be appreciated that in the event where no channel having a channel quality better than the channel quality of the first channel 212 by at least the predetermined amount is available, no reassignment signal may be transmitted and the first wireless microphone continues to use the assigned first channel 212. Although not shown in the flowchart it should be appreciated that steps 330 through 336 may be performed for other wireless microphones, e.g., wireless microphone 106, that are communicating with the microphone receiver 102 and/or have been assigned communications channels earlier. Operation proceeds from step 336 back to step 304 via connecting node C 338, and the wireless microphone receiver continues to monitor to receive channel assignment request from one or more wireless microphones in the system 100.

Referring now to connecting node A 303 via which the operation proceeds from step 302 to step 309 illustrated in FIG. 3B. In step 309 the wireless microphone receiver 102 receives at least one signal from each of the first and second wireless microphones 104, 106. In some embodiments the received at least one signal from each of the first and second wireless microphones 104, 106 is, e.g., a pilot signal or a control channel signal, transmitted at a known power level. In some embodiments the wireless microphone receiver 102 measures the received power level of the at least one signal received from each of the first and second wireless microphones 104, 106 to measure channel noise/interference associated with the respective channels used by the first and second wireless microphones 104, 106.

Operation proceeds from step 309 to step 311. In step 311 the wireless microphone receiver 102 transmits unicast transmission power control commands to said first wireless microphone 104 and a second wireless microphone 106 to individually control the transmission power level of audio signals transmitted by said first and second wireless microphones (104, 106), said unicast transmission power control commands including a first transmission power control command directed to the first wireless microphone 104 and a second transmission power control command directed to the second wireless microphone 106, the first transmission power control command being a function of a received signal power of a signal received from said first wireless microphone 104 and the second transmission power control command being a function of a received power of a signal received from the second wireless microphone 106. Thus the transmit power of the individual wireless microphones communicating with the wireless microphone receiver 102 maybe, and in various embodiments is, controlled by the wireless microphone receiver 102. In various embodiments wireless microphones in system 100 transmit audio data to said wireless microphone receiver 102 but do not receive audio data from said wireless microphone receiver 102. Operation proceeds from step 311 back to step 309 and may be repeated, e.g., on a periodic basis.

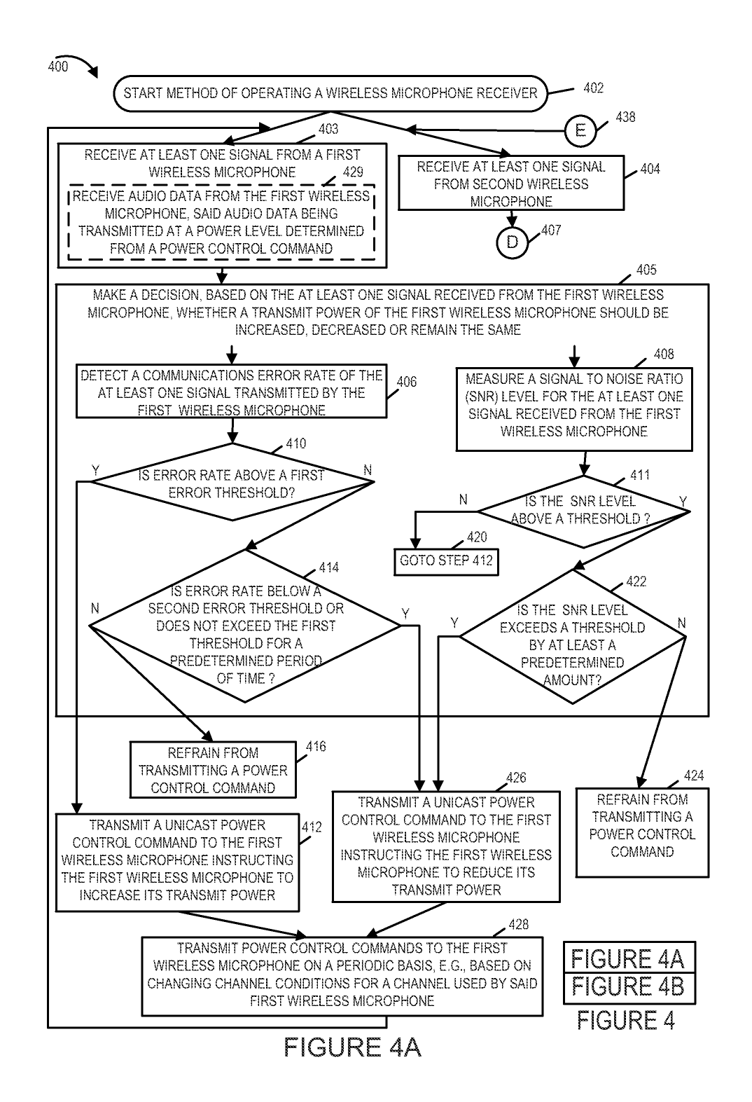

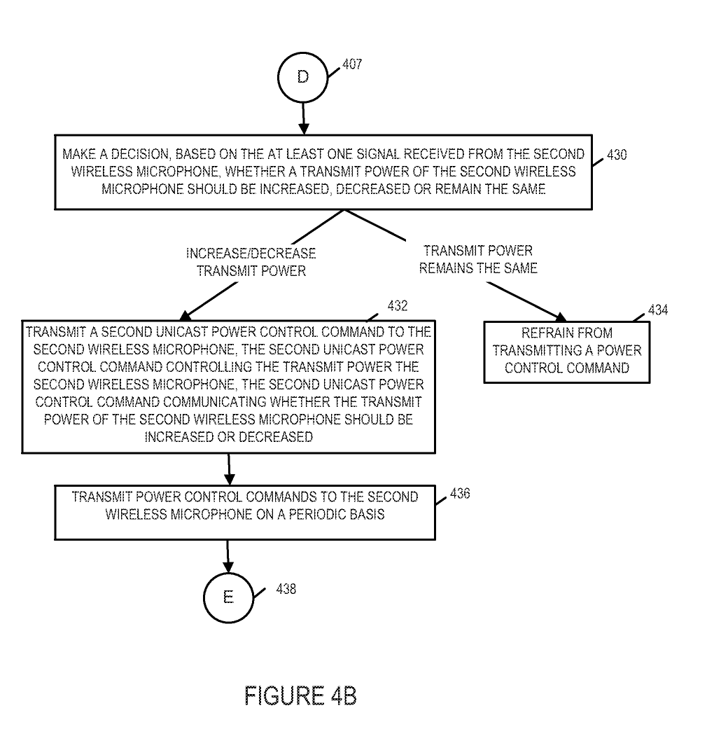

FIG. 4, which comprises a combination of FIGS. 4A and 4B, is a flowchart 400 illustrating the steps of an exemplary method of operating a wireless microphone receiver, in accordance with an exemplary embodiment. The wireless microphone receiver implementing the power control method of flowchart 400 is, e.g., wireless microphone receiver 102 of system 100 of FIG. 1. As will be discussed, in accordance with one aspect of some embodiments, the wireless microphone receiver 102 controls the transmission power of the wireless microphone transmitters in the system. The wireless microphone receiver 102 may instruct the wireless microphones to increase or decrease their transmission power as channel conditions change and/or on a recurring periodic basis.

The method of flowchart 400 shown in FIG. 4 starts in step 402, when the wireless microphone receiver 402 is powered on and initialized. Operation proceeds from start step 402 to steps 403 and 404 which are performed asynchronously in some embodiments.

In step 403 the wireless microphone receiver 102 receives at least one signal from a first wireless microphone, e.g., wireless microphone 104. The received signal may be a wireless microphone traffic signal, e.g., audio signal, from the first wireless microphone 104. Step 403 may, and sometimes does, include step 429 in which the wireless microphone receiver receives audio data from the first wireless microphone, said audio data being transmitted at a power level determined from a power control command, e.g., a previously received unicast power control command that was directed to the first wireless microphone. Operation proceeds from step 403 to step 405.

Similarly in step 404, the wireless microphone receiver 102 receives at least one signal from a second wireless microphone, e.g., wireless microphone 106. The received signal may be a wireless microphone traffic signal, e.g., audio signal, from the second wireless microphone 106. The operation proceeds from step 404 to step 430 via connecting node D 407.

Returning now to step 405. In step 405 the wireless microphone receiver 102 makes a decision, based on the at least one signal received from the first wireless microphone 104, whether a transmit power of the first wireless microphone 104 should be increased, decreased or remain the same. Thus in step 405 an analysis is performed to determine and decide whether or not any adjustment in the transmit power of the first wireless microphone 104 should be made. In some embodiments step 405 includes performing steps 406, 410 and 414. In some embodiments step 405 includes performing steps 408, 411 and 422. In some embodiments step 405 includes performing steps 406, 410 and 414 along one processing path and performing steps 408, 411 and 422 along another processing path, the processing along each processing path may be performed asynchronously in parallel. As discussed in greater detail below, in response to deciding in step 405 that the transmit power of a wireless microphone, e.g., the first wireless microphone 104, should be increased or decreased, the wireless microphone receiver 102 transmits a unicast power control command to the first wireless microphone 104, the power control command controlling the transmit power of the first wireless microphone. In some embodiments the power control command instructs the first wireless microphone 104 to change its transmit power used to transmit data signals to a power level specified by said unicast power control command. In some embodiments the power control command instructs the first wireless microphone 104 to change it's transmit power used to transmit data signals by a predetermined step size. In various embodiments, no power control command is transmitted when the decision is that the transmit power of the first wireless microphone 104 should remain the same.

In step 406 the communications errors in the received at least one signal are determined. In step 406 the wireless microphone receiver 102 detects a communications error rate of the received at least one signal, which was transmitted by the first wireless microphone 104. For example, the wireless microphone receiver 102 may determine bits errors or packets errors by calculating how many received bits or packets are erroneous or could not be recovered correctly, out of the total number of information bits communicated by the received at least one signal from the first wireless microphone 104. Thus based on such a calculation an error rate can be determined. In some embodiments the communications errors may be packet errors.

Operation proceeds from step 406 to step 410. In step 410 the wireless microphone receiver 102 determines if the determined communications error rate is above an error rate threshold, e.g., a first threshold. If it is determined that the error rate is above the first error threshold, the operation proceeds from step 410 to step 412. It should be appreciated that the determination that the communications error rate exceeds a threshold indicates that the number or errors in the received signal is over an allowed tolerance level and thus an action should be taken so that information communicated by the at least one signal can be correctly recovered, e.g., with acceptable amount of communications errors.

In step 412 the wireless microphone receiver 102 transmits a unicast power control command to the first wireless microphone 104 instructing the wireless microphone 104 to increase the transmit power that the first wireless microphone 104 is using for signal transmission. Increasing the transmission power increases the probability of successful communication of signals from the first wireless microphone 104 to the microphone receiver 102. Upon the receipt of the power control command from the wireless microphone receiver 102, the first wireless microphone 104 increases the transmit power as instructed. Operation proceeds from step 412 to step 428.

Referring again to step 410. If in step 410 it is determined that the error rate is not above the error rate threshold, the operation proceeds from step 410 to step 414. In step 414 it is determined if the determined error rate is below a second error threshold or the communications errors detected in a period of time do not exceed the first error threshold for a predetermined period of time. In some embodiments in step 414 it is determined whether the determined error rate is below the error rate threshold by at least a predetermined amount, to check that the error rate, e.g., communications errors detected in a period of time, is well below an allowed limit. In some embodiments such an indication helps the microphone receiver 102 in making a decision if transmit power of the first wireless microphone 104 should be, e.g., reduced, since the detected communications errors are low and thus signals transmitted at reduced power from the first wireless microphone 104 may still be received successfully. Moreover reducing the transmit power normally reduces the interference caused to other wireless microphones.

If in step 414 it is determined that the determined error rate is not below a second error threshold, then the operation proceeds from step 414 to step 416. In step 416 the wireless microphone receiver 102 refrains from transmitting a power control command to the first wireless microphone 104. However, if in step 414 it is determined that the error rate is below the second error threshold or is below the first error threshold by at least a predetermined amount, the operation proceeds from step 414 to step 426.

Returning now to step 408. In step 408 the wireless microphone receiver 102 measures a signal to noise ratio (SNR) for the at least one signal received from the first wireless microphone 104. The measured SNR level provides an estimate of the channel conditions and/or interference levels. Operation proceeds from step 408 to step 411. In step 411 it is determined if the measured SNR level is above a threshold, e.g., a target SNR threshold. If it is determined that the SNR level is below the target SNR threshold, the operation proceeds from step 411 to step 420 where the wireless microphone receiver 102 performs the operation discussed with regard to step 412 above, i.e., the wireless microphone receiver 102 transmits a unicast power control command instructing the first wireless microphone 104 to increase its transmit power.

If in step 411 it is determined that the SNR level is above the target SNR threshold, the operation proceeds to step 422. In step 422 the wireless microphone receiver 102 determines whether or not the SNR level exceeds the target SNR threshold by at least a predetermined amount. If it is determined that the SNR level does not exceed the target SNR threshold by at least a predetermined amount, the operation proceeds from step 422 to step 424. In step 424 the wireless microphone receiver 102 refrains from transmitting the power control command and thus no adjustments to the transmission power are made by the first wireless microphone 104 at the given time. If in step 422 it is determined that the SNR level exceeds the target SNR threshold by at least a predetermined amount, the operation proceeds from step 422 to step 426.

In step 426 the wireless microphone receiver 102 transmits a unicast power control command to the first wireless microphone 104 instructing the first microphone 104 to reduce its transmit power. Thus it should be appreciated that in various embodiments the wireless microphone receiver 102 makes appropriate determinations, e.g., such as the ones discussed with regard to steps 410, 414, 411, and 422, to decide how to control the transmit power used by a wireless microphone such as the first microphone 104 in an effective way which may improve successful recovery of signals transmitted from the wireless microphone without causing significant interference to other wireless microphones. Operation proceeds from step 426 to step 428.

In step 428 the wireless microphone receiver 102 controls the transmission of power control signals to the first wireless microphone 104 on a periodic basis, e.g., based on changing channel conditions for a channel used by the first wireless microphone 104. In some embodiments the wireless microphone receiver 102 transmits the power control signals on a periodic basis with a time spacing exceeding 1 second. In some other embodiments a different time spacing can be used.

Referring now to connecting node D 407 via which the operation proceeds from step 404 to step 430 shown in FIG. 4B. In step 430 the wireless microphone receiver 102 makes a decision, based on the at least one signal received from the second wireless microphone 106, whether a transmit power of the second wireless microphone 106 should be increased, decreased or remain the same. The operation in step 430 is similar to the processing discussed with regard to step 405. Although not shown in FIG. 4B, performing step 430 may also include performing steps similar to steps 406, 408, 410, 411, 414, 420 and 422 discussed with regard to decision making step 405. However the processing in step 430 relates decision making based on the signal received from the second wireless microphone 106.

When in step 430 it is decided that the transmit power of the second wireless microphone 106 should be increase or decreased, the operation proceeds from step 430 to step 432, otherwise if the it is decided that the transmit power of the second wireless microphone 106 should remain the same, the operation proceeds to step 434.

In step 432 the wireless microphone receiver 102 transmits a second unicast power control command to the second wireless microphone 106, the second unicast power control command controlling the transmit power of the second wireless microphone 106, the second power control command communicating whether the transmit power of the second wireless microphone should be increased or decreased. As should be appreciated, the second unicast power control command is transmitted as a function of the decision made in the decision step 430 whether the transmit power of the second wireless microphone 106 should be increased, decreased or remain the same. In various embodiments the power control commands are transmitted by the wireless microphone receiver 102 to wireless microphones at a predetermined fixed transmission power level. In various embodiments the wireless microphones transmit audio data to the wireless microphone receiver 102 but do not receive audio data from said wireless microphone receiver 102.

Operation proceeds from step 432 to step 436. In step 436 the wireless microphone receiver 102 controls the transmission of power control signals to the second wireless microphone 106 on a periodic basis, e.g., based on changing channel conditions for a channel used by the second wireless microphone 106. The operation proceeds from step 436 back to step 404 via connecting node E 438.

If in step 430 a decision is made that the transmit power of the second wireless microphone should remain the same, the operation proceeds from step 430 to step 434. In step 434 the wireless microphone receiver 102 refrains from transmitting a power control command based on the decision in step 430 that the transmit power of the second wireless microphone should remain the same.

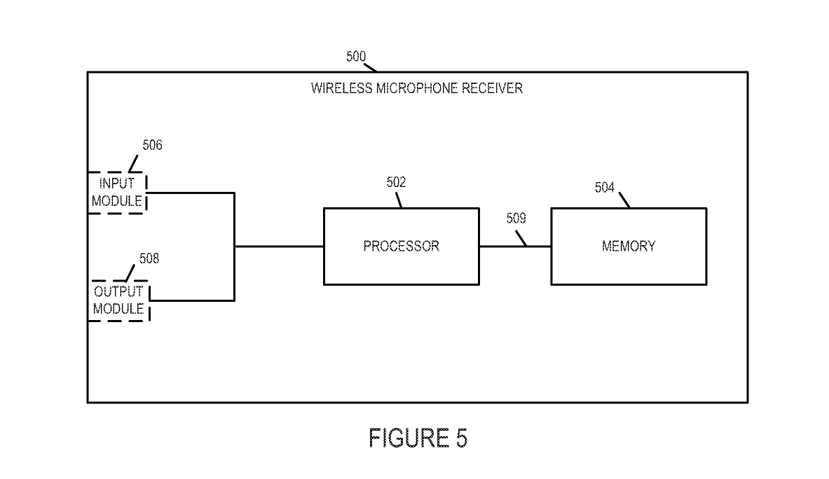

FIG. 5 is a drawing of an exemplary wireless microphone receiver device 500, in accordance with an exemplary embodiment. Exemplary wireless microphone receiver 500 may be used as the wireless microphone receiver 102 of FIG. 1 Exemplary wireless microphone receiver 500 may, and sometimes does, implement a method in accordance with flowchart 300 of FIG. 3 and a method in accordance with flowchart 400 of FIG. 4.

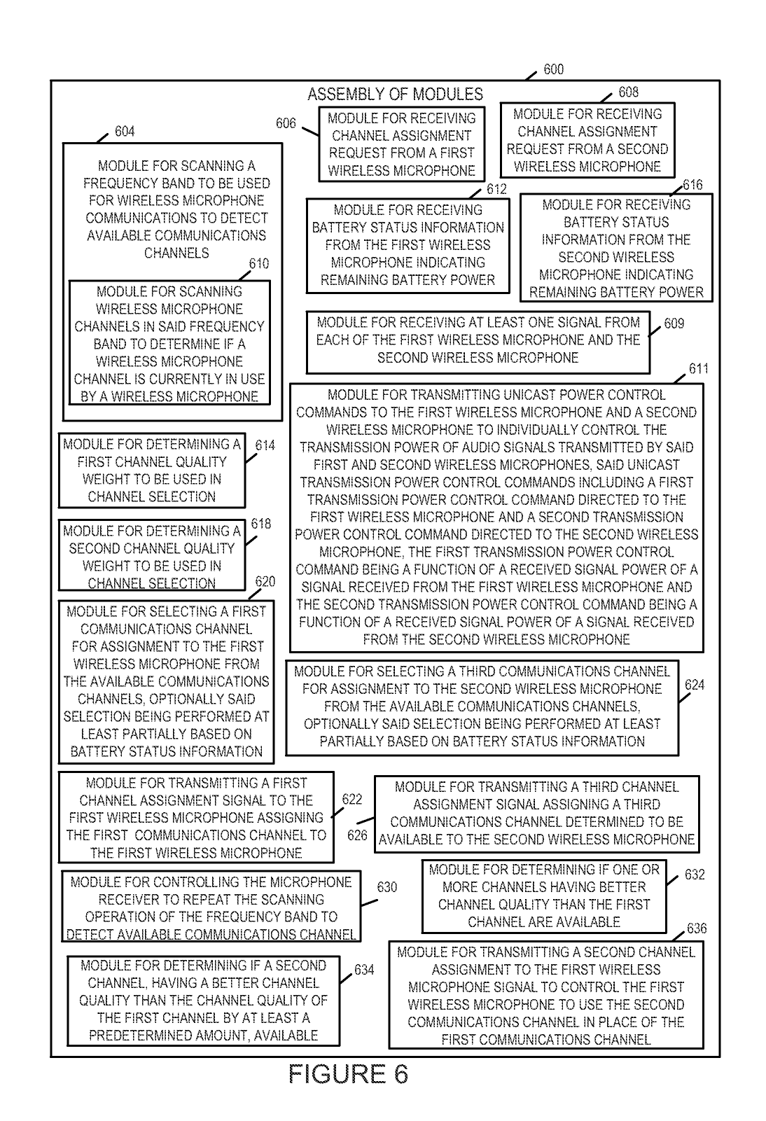

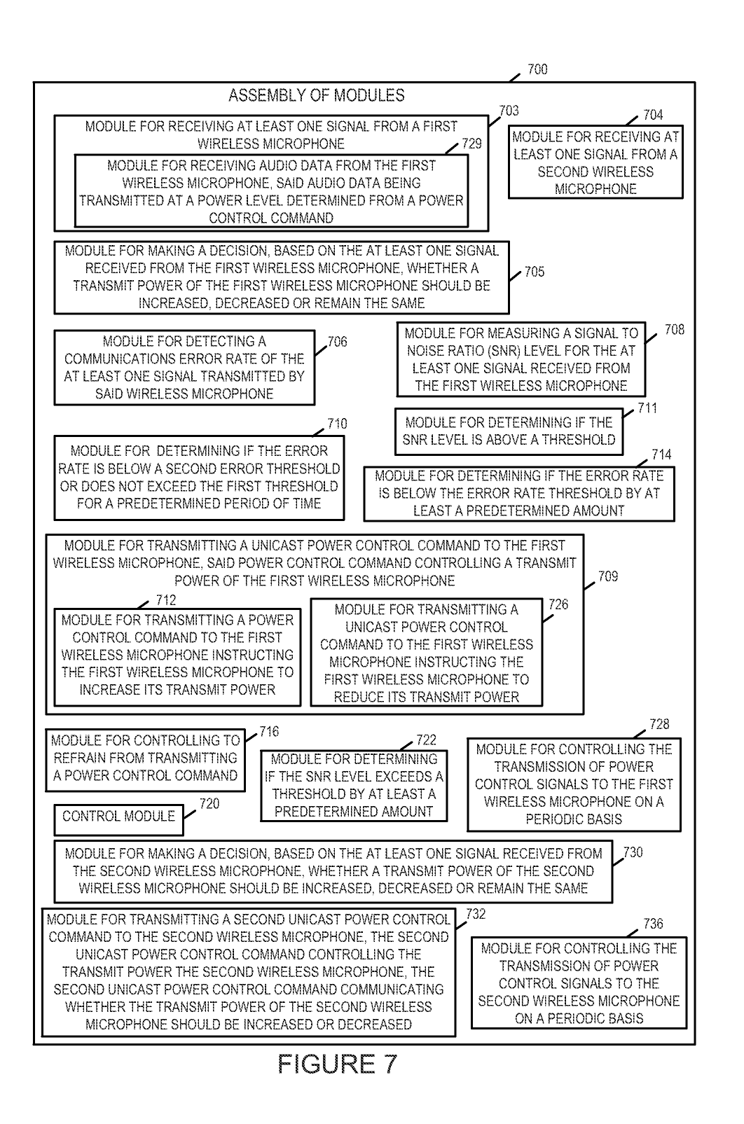

The wireless microphone receiver 500 includes a processor 502 and memory 504 coupled together via a bus 509 over which the various elements (502, 504) may interchange data and information. The memory 504 may include an assembly of modules used to control the wireless microphone receiver 500, e.g., such as the assembly of modules shown in FIGS. 6 and 7. The wireless microphone receiver 500 further includes an input module 506 and an output module 508 which may be coupled to processor 502 as shown. However, in some embodiments, the input module 506 and output module 508 are located internal to the processor 502. Input module 506 can receive input signals. Input module 506 can, and in some embodiments does, include a wireless receiver and/or a wired or optical input interface for receiving input. Output module 508 may include, and in some embodiments does include, a wireless transmitter and/or a wired or optical output interface for transmitting output.

In various embodiments, processor 502 is configured to scan a frequency band to be used for wireless microphone communications to detect available communications channels, the available communications channels including a first communications channel; and transmit a channel assignment signal to a first wireless microphone, e.g., wireless microphone 104, assigning the first communications channel to said first wireless microphone. In various embodiments the processor 502 is configured to receive a channel assignment request from the first wireless microphone prior to the transmission of the first channel assignment signal. In some embodiments the processor 502 is further configured to receive a channel assignment request from a second wireless microphone.

The processor 502, in some embodiments, is further configured to receive at least one signal from each of the first and second wireless microphones 104, 106. In some embodiments, processor 502 is further configured to transmit unicast transmission power control commands to said first wireless microphone 104 and a second wireless microphone 106 to individually control the transmission power level of audio signals transmitted by said first and second wireless microphones (104, 106), said unicast transmission power control commands including a first transmission power control command directed to the first wireless microphone 104 and a second transmission power control command directed to the second wireless microphone 106, the first transmission power control command being a function of a received power or a signal received from said first wireless microphone 104 and the second transmission power control command being a function of a received signal power of a signal received from the second wireless microphone 106. In some embodiments the processor 502 is further configured to measure the received power level of the at least one signal received from each of the first and second wireless microphones 104, 106 and estimate channel noise/interference associated with the respective channels used by the first and second wireless microphones 104, 106.

In various embodiments the processor 502 is further configured to scan, as part of scanning a frequency band to be used for wireless microphone communications to detect available communications channels, wireless microphone channels to determine if a wireless microphone channel is currently in use by another wireless microphone. In some embodiments the first communications channel is a wireless microphone channel on which no wireless microphone signals were detected in the scanning operation performed by the processor 502.

Processor 502 is further configured to receive battery status information from the first wireless microphone indicating the remaining battery power. In some embodiments the processor 502 is further configured to determine a first channel quality weight to be used in making a channel selection decision for assignment to the first wireless microphone. In some such embodiments the processor 502 is further configured to make a channel assignment for the first wireless microphone based at least partially on the battery status information and information indicating channel quality of a plurality of available communications channels.

In some embodiments the processor 502 is further configured to receive battery status information from the second wireless microphone indicating the remaining battery power and determine a second channel quality weight to be used in making a channel selection decision for assignment to the second wireless microphone. In some such embodiments the processor 502 is further configured to make a channel assignment for the second wireless microphone based at least partially on the battery status information from the second wireless microphone and information indicating channel quality of a plurality of available communications channels. In various embodiments the processor 502 is further configured to assign a third communications channel to the second wireless microphone, e.g., wireless microphone 106.

In various embodiments the processor 502 is further configured to repeat the scanning operation of said frequency band to detect available communications channels; and determine if one or more channel having a better channel quality than the channel quality of the first communications channel are available. In some embodiments the processor 502 is further configured to transmit, when it is determined that a second communications channel having a better channel quality than the channel quality of the first communications channel is available, a signal reassigning the second communications channel to the first wireless microphone, the second communications channel having better channel quality than said first communications channel. In some embodiments the processor 502 is configured to scan one or more frequency to be used for wireless microphone communications to detect available communications channels, on a periodic basis.

Exemplary wireless microphone receiver 500 may, and sometimes does, implement a method in accordance with flowchart 400 of FIG. 4. In some embodiments the processor 502 is configured to receive at least one signal from a first wireless microphone, e.g., wireless microphone 104, and detect communications errors, e.g., bit errors, packet errors etc., in the at least one signal transmitted by the first wireless microphone. In some embodiments the processor 502 is further configured to receive at least one signal from a second wireless microphone, e.g., wireless microphone 106.

In some embodiments the processor 502 is further configured to detect a communications error rate of the at least one signal transmitted by the first wireless microphone 104, e.g., by determining errors in a period of time. In some embodiments the processor 502 is further configured to determine if the error rate exceeds an error rate threshold, e.g., a first error threshold. In some embodiments the processor 502 further configured to determine if the error rate is below an error rate threshold by at least a predetermined amount.

In various embodiments the processor 502 is configured to measure a signal to noise ratio (SNR) for the at least one signal received from the first wireless microphone 104. In some such embodiments the processor 502 is further configured to determine if the SNR level is above a threshold level and/or below a target SNR threshold. In some such embodiments the processor 502 is further configured to determine if the SNR level exceeds a threshold level by at least a predetermined amount. The processor 502 in various embodiments is configured to make a decision, based on the at least one signal received from said first wireless microphone, whether a transmit power of the first wireless microphone should be increased, decreased or remain the same. In some embodiments the processor 502 makes the decision based on one or more factors such as the determined communications error rate and/or SNR for the at least one signal received from the first wireless microphone 104, discussed above.

In some embodiments the processor 502 is further configured to control the transmit power of the first wireless microphone 104 based on at least one of: i) communications error rate of the at least one signal received from the first wireless microphone 104, or ii) SNR level of the at least one signal received from the first wireless microphone 104. In various embodiments the processor 502 is further configured to transmit, when it is decided that the transmit power of a wireless microphone, e.g., the first wireless microphone 104, should be increased or decreased, a unicast power control command to the first wireless microphone 104, the power control command controlling the transmit power of the first wireless microphone 104. In some embodiments the power control command instructs the first wireless microphone 104 to change its transmit power used to transmit data signals to a power level specified by said power control command. In some embodiments the power control command instructs the first wireless microphone 104 to change it's transmit power used to transmit data signals by a predetermined step size. In various embodiments, no power control command is transmitted when the decision is that the transmit power of the first wireless microphone 104 should remain the same.

In some embodiments the processor 502 is configured to transmit a unicast power control command to the first wireless microphone 104 instructing the first wireless microphone 104 to increase its transmit power when a signal to noise level for the at least one signal from the first wireless microphone 104 is below the target SNR threshold. In some embodiments the processor 502 is configured to transmit a power control command to the first wireless microphone 104 instructing the first wireless microphone 104 to decrease or reduce its transmit power when the communications errors detected in a period of time are below a second threshold or do not exceed said first threshold for a predetermined period of time. In some embodiments the processor 502 is configured to transmit a power control command to the first wireless microphone 104 instructing the first wireless microphone 104 to reduce its transmit power when the measured SNR level for the at least one signal received from said first wireless microphone 104 exceeds a target SNR threshold by at least a predetermined amount. In some embodiments the processor 502 is configured to transmit a power control command to the first wireless microphone 104 instructing the first wireless microphone 104 to change its transmit power used to transmit data signals by a predetermined step size. In various embodiments the transmitted power control command instructs the first wireless microphone 104 to change its transmit power used to transmit data signals to a power level specified by said power control command.

In some embodiments the processor 502 is further configured to make a decision, based on the at least one signal received from the second wireless microphone 106, whether a transmit power of the second wireless microphone 106 should be increased, decreased or remain the same; and transmit a second unicast power control command to the second wireless microphone 106, the second unicast power control command controlling the transmit power of the second wireless microphone 106, the second power control command communicating whether the transmit power of the second wireless microphone should be increased or decreased. In various embodiments the processor 502 is configured to transmit the second unicast power control command as a function of the decision whether the transmit power of the second wireless microphone 106 should be increased or decreased.

In various embodiments the processor 502 is further configured to transmit the power control commands to wireless microphones at a predetermined fixed transmission power level. In some embodiments the processor 502 is configured to transmit power control signals, e.g., power control commands, to the first and second wireless microphones on a periodic basis. In some embodiments the processor 502 is further configured to transmit power control signals on a periodic basis with a time spacing exceeding 1 second. In some embodiments when a decision is made that the transmit power of the first and second wireless microphones should remain the same, the processor 502 is further configured to refrain from transmitting a power control command to the first and second wireless microphones 104, 106.

In some embodiments, processor 502 is configured to: transmit a unicast power control command to a first wireless microphone, said power control command controlling a transmit power of said first wireless microphone; and receive audio data from the first wireless microphone, said audio data being transmitted at a power level determined from said power control command. In some such embodiments, processor 502 is further configured to make a decision, based on a signal received from said first wireless microphone, whether the transmit power of the first wireless microphone should be increased, decreased or remain the same.

In various embodiments, processor 502 is further configured transmit said unicast power control command to said first wireless microphone in response to deciding that the transmit power of the first wireless microphone should be increased or decreased, said at least processor being configured to refrain from transmitting said power control command when the decision is that the transmit power of the first wireless microphone should remain the same.

In some embodiments, processor 502 is configured to: transmit power control signals to said first wireless microphone on a periodic basis. In some such embodiments, processor 502 is further configured to control transmission of power control signals on a periodic basis with a time spacing exceeding 1 second.

In some embodiments, processor 502 is configured to detect communications errors in at least one signal transmitted by said first wireless transmitter, and said transmitted power control command is a signal instructing the first wireless transmitter to increase its transmit power when the communications errors detected in a period of time exceed a first error threshold. In some embodiments, said transmitted power control command is a signal instructing the first wireless microphone to decrease its transmit power when the communications errors detected in a period of time are below a second threshold or do not exceed said first threshold for a predetermined period of time. In some embodiments, said transmitted power control command is a signal instructing the first wireless microphone to increase its transmit power when a signal to noise level for the at least one signal received from said first wireless microphone is below a target SNR threshold. In various embodiments, said transmitted power control command is a signal instructing the first wireless microphone to reduce its transmit power when a signal to noise level for the at least one signal received from said first wireless microphone exceeds a target SNR threshold by at least a predetermined amount.

In some embodiments, said power control command instructs the first wireless microphone to change its transmit power used to transmit data signals to a power level specified by said power control command. In various embodiments, said power control command instructs the first wireless microphone to change its transmit power used to transmit data signals by a predetermined step size.

Processor 502, in some embodiments, is configured to: make a decision, based on a signal received from a second wireless microphone, whether a transmit power of the second wireless microphone should be increased, decreased or remain the same and transmit a second unicast power control command to the second wireless microphone, said second unicast power control command controlling the transmit power of the second wireless microphone, said second unicast power control command communicating whether transmit power of the second wireless microphone should be increased or decreased, said second unicast power control command being transmitted in response to making a decision that the transmit power of the second wireless microphone should be increased, or decreased.

In various embodiments processor 502 is configured to transmit power control commands to wireless microphones at a predetermined fixed transmission power level. In some embodiments, the wireless microphones transmit audio data to said wireless microphone receiver but do not receive audio data from said wireless microphone receiver.

FIG. 6 illustrates an assembly of modules 600 which can, and in some embodiments is, used in a wireless microphone receiver such as the wireless microphone receiver 500 illustrated in FIG. 5 or the wireless microphone receiver 102 illustrated in FIG. 1. The modules in the assembly 600 can be implemented in hardware within the processor 502 of FIG. 5, e.g., as individual circuits. Alternatively, the modules may be implemented in software and stored in the memory 504 of the wireless microphone receiver 500 shown in FIG. 5. While shown in the FIG. 5 embodiment as a single processor, e.g., computer, it should be appreciated that the processor 502 may be implemented as one or more processors, e.g., computers.

When implemented in software the modules include code, which when executed by the processor, configure the processor, e.g., computer, 502 to implement the function corresponding to the module. In some embodiments, processor 502 is configured to implement each of the modules of the assembly of modules 600. In embodiments where the assembly of modules 600 is stored in the memory 504, the memory 504 is a computer program product comprising a computer readable medium comprising code, e.g., individual code for each module, for causing at least one computer, e.g., processor 502, to implement the functions to which the modules correspond.

Completely hardware based or completely software based modules may be used. However, it should be appreciated that any combination of software and hardware (e.g., circuit implemented) modules may be used to implement the functions. As should be appreciated, the modules illustrated in FIG. 6 control and/or configure the wireless microphone receiver 500 or elements therein such as the processor 502, to perform the functions of the corresponding steps illustrated and/or described in the method of flowchart 300 of FIG. 3.

The assembly of modules 600 includes a module corresponding to each step of the method of flowchart 300 shown in FIG. 3. For example module 604 corresponds to step 304 and is responsible for performing the operation described with regard to step 304. The assembly of modules 600 includes a module 604 for scanning a frequency band to be used for wireless microphone communications to detect available communications channel, a module 606 for receiving a channel assignment request from a first wireless microphone, and a module 608 for receiving a channel assignment request from a second wireless microphone. In various embodiments the module 604 further includes a module 610 for scanning wireless microphone channels in said frequency band to determine if a channel is currently in use by a wireless microphone.

The assembly of modules 600 further includes a module 609 for receiving at least one signal from each of the first and second wireless microphones 104, 106, and a module 611 for transmitting unicast transmission power control commands to said first wireless microphone and a second wireless microphone to individually control the transmission power level of audio signals transmitted by said first and second wireless microphones, said unicast transmission power control commands including a first transmission power control command directed to the first wireless microphone and a second transmission power control command directed to the second wireless microphone, the first transmission power control command being a function of a received signal power of a signal received from the first wireless microphone and the second transmission power control command being a function of a received power of a signal received from the second wireless microphone. In some embodiments the module 609 also performs measurement of the received power level of the at least one signal received from each of the first and second wireless microphones 104, 106 to measure channel noise/interference associated with the respective channels used by the first and second wireless microphones.

The assembly of modules 600 further includes a module 612 for receiving battery status information from the first wireless microphone indicating remaining battery power, a module 614 for determining a first channel quality weight to be used in selecting a communications channel for assignment to the first wireless microphone, a module 616 for receiving battery status information from the second wireless microphone indicating remaining battery power, a module 618 for determining a second channel quality weight to be used in selecting a communications channel for assignment to the second wireless microphone.

The assembly of modules 600 further includes a module 620 for selecting a first communications channel, e.g., channel 212, for assignment to the first wireless microphone 104 from the available communications channels. The first channel quality weight determined by module 614 is an input to selection module 620 and in some embodiments the selection module selects the first communications channel for assignment to the first wireless microphone at least partially based on the battery status information. Assembly of modules 600 further includes a module 622 for transmitting a first channel assignment signal to the first wireless microphone assigning the first communications channel to the first wireless microphone 104. In some embodiments the first communications channel is a wireless microphone channel on which no wireless microphone signals were detected by the scanning operation performed by module 604.

The assembly of modules 600 further includes a module 624 for selecting a third communications channel, e.g., channel 216, for assignment to the second wireless microphone 106 from the available communications channels, and a module 626 for transmitting a third channel assignment signal assigning a third communications channel determined to be available to the second wireless microphone 106. In some embodiments the selection module 624 selects a third communications channel for assignment to the second wireless microphone 106 at least partially based on batter status information received from the second wireless microphone 106.

Assembly of modules 600 in some embodiments further includes a module 630 for controlling the wireless microphone receiver 500 or more specifically for controlling the scanning module 604 to repeat the scanning operation of the frequency band to detect available communications channels and/or to detect interference/noise conditions on one or more available communications channels. The assembly of modules 600 in some embodiments further includes a module 632 for determining if one or more channels having a better channel quality than the channel quality of the first channel 212 are available, a module 634 for determining if a second channel 214, having a better channel quality than the channel quality of the first channel 212 by at least a predetermined amount is available, and a module 636 for transmitting a second channel assignment signal to the first wireless microphone 104 to control the first wireless microphone to use the second communications channel 214 in place of the first communications channel, the second channel 214 having a better channel quality than the channel quality of the first communications channel by at least a predetermined amount.

FIG. 7 illustrates another assembly of modules 700 which can, and in some embodiments is, used in a wireless microphone receiver 500 illustrated in FIG. 5. The modules in the assembly 700 can be implemented in hardware within the processor 502 of FIG. 5, e.g., as individual circuits. Alternatively, the modules may be implemented in software and stored in the memory 504 of the wireless microphone receiver 500 shown in FIG. 5. While shown in the FIG. 5 embodiment as a single processor, e.g., computer, it should be appreciated that the processor 502 may be implemented as one or more processors, e.g., computers.

When implemented in software the modules include code, which when executed by the processor, configure the processor, e.g., computer, 502 to implement the function corresponding to the module. In some embodiments, processor 502 is configured to implement each of the modules of the assembly of modules 700. In embodiments where the assembly of modules 700 is stored in the memory 504, the memory 504 is a computer program product comprising a computer readable medium comprising code, e.g., individual code for each module, for causing at least one computer, e.g., processor 502, to implement the functions to which the modules correspond.

Completely hardware based or completely software based modules may be used. However, it should be appreciated that any combination of software and hardware (e.g., circuit implemented) modules may be used to implement the functions. As should be appreciated, the modules illustrated in FIG. 7 control and/or configure the wireless microphone receiver 500 or elements therein such as the processor 502, to perform the functions of the corresponding steps illustrated and/or described in the method of flowchart 400 of FIG. 4.

The assembly of modules 700 includes a module corresponding to each step of the method of flowchart 400 shown in FIG. 4. For example module 704 corresponds to step 404 and is responsible for performing the operation described with regard to step 404. The assembly of modules 700 includes a module 703 for receiving at least one signal from a second wireless microphone 106, a module 704 for receiving at least one signal from a first wireless microphone 104, a module 705 for making a decision based on the at least one signal received from the first wireless microphone whether a transmit power of the first wireless microphone should be increased, decreased or remain the same, a module 706 for determining a communications error rate of the received at least one signal transmitted by the first wireless microphone 104, and a module 708 for measuring a signal to noise ratio (SNR) for the at least one signal received from the first wireless microphone 104. Module 403 includes a module 729 for receiving audio data from the first wireless microphone, said audio data being transmitted at a power level determined from said power control command.

In various embodiments the assembly of modules 700 further includes a module 710 for determining if the communications error rate is above an error rate threshold, e.g., a first error threshold, a module 711 for determining if the measured SNR level is above a threshold, e.g., a predetermined threshold level, a module 714 for determining if the communications error rate is below the error rate threshold by at least a predetermined amount, and a module 722 for determining whether or not the SNR level exceeds a threshold by at least a predetermined amount. In some embodiments the decision module 705 receives input from modules 706, 708, 710, 711, 714 and 722 and performs the decision making operation based on the input from one or more of these modules.

The assembly of modules 700 further includes a module 712 for transmitting a power control command to the first wireless microphone 104 instructing the first wireless microphone 104 to increase its transmit power. The module 712 receives input from modules decision module 705 regarding the decision to transmit a power control command to the first wireless microphone 104. Assembly of modules 700 in some embodiments further includes a module 716 for controlling the wireless microphone receiver 500 to refrain from transmitting a power control command, a control module 720 for controlling the wireless microphone receiver 500 or the processor 502 to perform the functions discussed with regard to module 712 when it is determined by the module 711 that the determined SNR is below a threshold level. It should be appreciated that the module 716 performs the functions discussed with regard to step 416, 424 and 434 of the method of flowchart 400.

In various embodiments the assembly of modules 700 further includes a module 726 for transmitting a power control command to the first wireless microphone 104 instructing the first microphone 104 to reduce its transmit power. In various embodiments the module 726 performs the operation of transmitting the power control signal to reduce the transmit power of the first device based on the input from the decision module 705. In some embodiments the assembly of modules 700 includes a module 728 for controlling the transmission of power control signals, e.g., power control commands, to the first wireless microphone 104 on a periodic basis, e.g., based on changing channel conditions for a channel used by the first wireless microphone 104. In some embodiments the module 728 controls the wireless microphone receiver 500 to transmit the power control signals on a periodic basis with a time spacing exceeding 1 second.

In various embodiments the assembly of modules 700 further includes a module 730 for making a decision, based on the at least one signal received from the second wireless microphone 106, whether a transmit power of the second wireless microphone 106 should be increased, decreased or remain the same. The module 730 performs the processing discussed with regard to step 430. In some embodiments the module 730 includes sub-modules to perform processing similar to the processing performed by modules similar to modules 706, 708, 710, 711, 714 and 722 discussed above, however it should be appreciated that the processing performed by modules 730 relates decision making based on the signal received from the second wireless microphone 106.

The assembly of modules 700 further includes a module 732 for transmitting a second unicast power control command to the second wireless microphone 106, the second unicast power control command controlling the transmit power of the second wireless microphone 106, the second power control command communicating whether the transmit power of the second wireless microphone should be increased or decreased. The modules 732 receives input from the decision module 730 and transmits the power control command to the second wireless microphone 106 when the input from the decision module 730 communicates that the transmit power of the second wireless microphone 106 should be increased or decreased. In various embodiments the processor 502 controls the wireless microphone receiver 500 to transmit the power control commands to wireless microphones at a predetermined fixed transmission power level. In various embodiments the wireless microphones transmit audio data to the wireless microphone receiver 500 but do not receive audio data from said wireless microphone receiver 500.

When the decision module 730 makes a decision that the transmit power of the second wireless microphone should remain the same, the module 716 controls the wireless microphone 500 to refrain from transmitting a power control command to the second wireless microphone 106. The assembly of modules 700 further includes a module 736 for controlling the transmission of power control signals, e.g., power control commands, to the second wireless microphone 106 on a periodic basis.

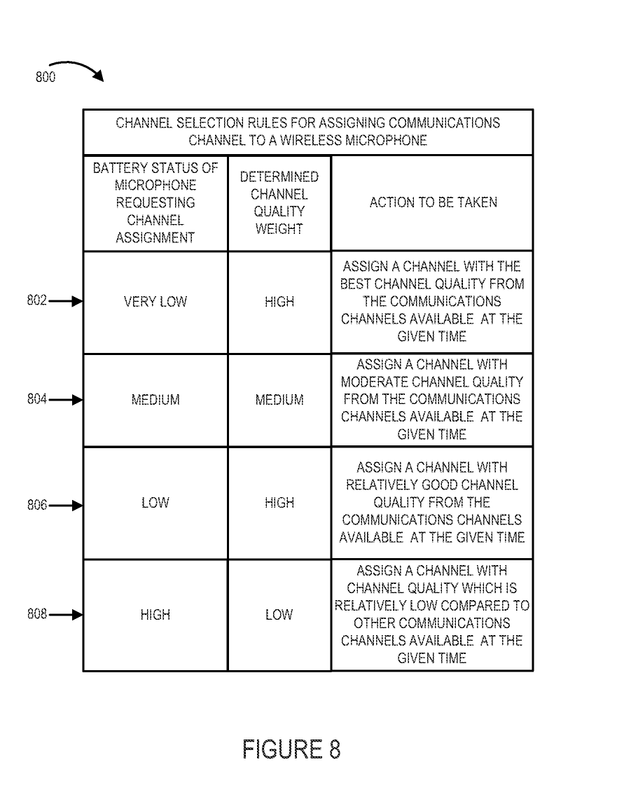

FIG. 8 is a table 800 illustrating exemplary channel selection rules for selecting a communications channel for assigning to a wireless microphone, in accordance with various exemplary embodiments. In some embodiments the channel selection rules are, e.g., stored in memory 504 of wireless microphone receiver 500 and used by the wireless microphone receiver 500 when implementing a method in accordance with flowchart 300 of FIG. 3.

Consider that a plurality of communications channels are detected to be available for assignment to the wireless microphones. Row 802 indicates that if the battery status information received from a wireless microphone indicates that the remaining battery power is very low, then the determined channel quality weight to be used in channel selection will be high and the wireless microphone receiver 500 may, and sometimes does, select, out of the plurality of available communications channels, a channel with the best channel quality. For example, if a plurality of communications channels are available and there are a number of wireless microphones seeking channel assignment, then the wireless microphone receiver 500 may compare the channel qualities of the available channels, and may assign a channel with the best channel quality to the microphone for which the remaining battery is very low and the determined channel quality weight is high. Thus in some embodiments a high quality channel with low interference is assigned to the wireless microphone with very low remaining battery power thus requiring less transmission power from said wireless microphone for successfully communicating with the microphone receiver 500.

Row 804 indicates that if the battery status information received from a wireless microphone indicates that the remaining battery power is in the medium range, then the determined channel quality weight to be used in channel selection will be medium and the wireless microphone receiver 500 may, and sometimes does, select a channel, out of the plurality of available communications channels, with moderate channel quality. Thus in some embodiments a channel with moderate channel quality and moderate interference is assigned to the wireless microphone with medium battery power. In some embodiments the wireless microphone receiver 500 instructs the wireless microphone to which the channel with moderate channel quality is assigned, to increase the transmit power if the channel quality of the assigned channel falls below a threshold level.

Row 806 indicates that if the battery status information received from a wireless microphone indicates that the remaining battery power is low, then the determined channel quality weight to be used in channel selection will be high and the wireless microphone receiver 500 may, and sometimes does, select, out of the plurality of available communications channels, a channel with relatively good channel quality as compared to other available channels for assignment to the wireless microphone with low remaining batter power.

Row 808 indicates that if the battery status information received from a wireless microphone indicates that the remaining battery power is low, then the determined channel quality weight to be used in channel selection will be low and the wireless microphone receiver 500 may, and sometimes does, select, out of the plurality of available communications channels, a channel with relatively average or low channel quality as compared to other available channels for assignment to the wireless microphone with high remaining batter power. However other factors may be also considered for channel assignment at times, for example, if a plurality of good quality channels are available and there are less number of wireless microphones seeking channel assignment, then a channel with good quality may be assigned. Thus in some embodiments a wireless microphone is not necessarily assigned a channel with an average channel quality just because its remaining battery power is high, or assigned a good channel just because its battery is low.

Lower RF frequencies tend to be more reliable than high RF frequencies for a given transmit power and coding rate. It should be appreciated that the majority of the communication in the wireless microphone system is used for transmission of audio data to a wireless microphone receiver. It should also be appreciated that wireless microphone receivers are, in many embodiments, stationary devices with access to AC power lines while wireless microphone transmitters are often battery powered devices. Taking these various factors into account, in at least some embodiments, lower RF frequencies are used for audio data transmission while higher RF frequencies are used for control signaling to/from wireless microphone transmitters. In this way, wireless microphone transmitters can make the most of their limited available transmit power by using the more reliable lower RF frequencies for the transmission of audio data allowing lower power and/or a lower amount of error correction coding to achieve reliable communication than would be required if higher frequency RF signals were used to communicate the audio data. While control signals are sent using the higher RF frequency band, many of the control signals are transmitted by the wireless microphone receiver which is less power constrained that the individual wireless microphone transmitters since the wireless microphone receiver is normally not limited to battery power. In addition, since the amount of control signaling is relativity small in the system, a higher degree of error correcting coding can be used for the control signaling without significantly impacting the amount of audio data which can be communicated using the limited available frequency resources.

By maintaining a large frequency separation between control signals and audio data signals, the chance of interference between the signals is minimized and in some embodiments, control and audio data communication may occur at the same time. For example, the wireless microphone receiver may transmit control signals and/or control information while one or more wireless microphone transmitters are simultaneously transmitting audio data to the wireless microphone receiver.

In some embodiments a wireless microphone receiver selects and assigns different channels to each of a plurality of wireless microphone transmitters for communication of control and/or audio information. For example, in some embodiments the wireless microphone receiver selects both a control channel and a separate audio channel to be used by a wireless microphone transmitter for signals sent to the wireless microphone receiver and communicates the channel assignments to the individual wireless microphone transmitter to which the channels are being assigned. In other embodiments a common uplink control signaling channel is shared by multiple wireless microphone transmitters and each wireless microphone transmitter is assigned at least one audio channel which is not shared with the other wireless microphone transmitters. As noted above, in some embodiments, the assigned or shared control channels used for sending control signals and information to the wireless microphone receiver are at a higher radio frequency (RF) than the audio channels used for communicating audio data to the wireless microphone receiver.

In some but not necessarily all embodiments, a wireless microphone transmitter transmits control information to the wireless microphone receiver using a higher transmission power level and/or level of error correcting coding than it uses for transmitting audio data to the wireless microphone transmitter. In some embodiments, the wireless microphone receiver transmits control signaling and/or control information to a wireless microphone transmitter using a transmit power level that is higher than the transmit power level used by the particular wireless microphone transmitter for transmitting control information and/or audio data to the wireless microphone receiver.

In many embodiments while the wireless microphone receivers may wirelessly transmit timing, power control and/or control signals or information over wireless links, in at least some embodiments the wireless microphone transmitters do not wirelessly transmit audio data to any device. In at least some such embodiments a wire or optical line is used to relay received audio information to a recording or other system. However, in other embodiments the wireless microphone receivers may wirelessly transmit audio data received from the wireless microphone transmitters to a recorder or some other device which is not a wireless microphone transmitter.

Various methods and apparatus described in this application are well suited for use in wireless microphone receivers, wireless microphone transmitters and networks supporting wireless microphone communications. In various embodiments a device of any of one or more of FIGS. 1-8 includes a module corresponding to each of the individual steps and/or operations described with regard to any of the Figures in the present application and/or described in the detailed description of the present application. The modules may, and sometimes are implemented in hardware. In other embodiments, the modules may, and sometimes are, implemented as software modules including processor executable instructions which when executed by the processor of the wireless communications device cause the device to implement the corresponding step or operation. In still other embodiments, some or all of the modules are implemented as a combination of hardware and software.

The techniques of various embodiments may be implemented using software, hardware and/or a combination of software and hardware. Various embodiments are directed to apparatus, e.g., wireless microphone receivers, control nodes, wireless microphone transmitters, microphone communications system. Various embodiments are also directed to methods, e.g., method of controlling and/or operating wireless microphone receivers, and wireless microphone transmitters, and microphone communications system. Various embodiments are also directed to a non-transitory machine, e.g., computer, readable medium, e.g., ROM, RAM, CDs, hard discs, etc., which include machine readable instructions for controlling a machine to implement one or more steps of a method.

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

In various embodiments nodes described herein are implemented using one or more modules to perform the steps corresponding to one or more methods, for example, signal receiving, processing, and/or transmission steps. Thus, in some embodiments various features are implemented using modules. Such modules may be implemented using software, hardware or a combination of software and hardware. Many of the above described methods or method steps can be implemented using machine executable instructions, such as software, included in a machine readable medium such as a memory device, e.g., RAM, floppy disk, etc. to control a machine, e.g., general purpose computer with or without additional hardware, to implement all or portions of the above described methods, e.g., in one or more nodes. Accordingly, among other things, various embodiments are directed to a machine-readable medium including machine executable instructions for causing a machine, e.g., processor and associated hardware, to perform one or more of the steps of the above-described method(s). Some embodiments are directed to a device, e.g., microphone device, including a processor configured to implement one, multiple or all of the steps of one or more above described methods.

In some embodiments, the processor or processors, e.g., CPUs, of one or more devices, e.g., microphone devices such as wireless microphone receivers and/or wireless microphone transmitters, are configured to perform the steps of the methods described as being performed by the microphone devices. The configuration of the processor may be achieved by using one or more modules, e.g., software modules, to control processor configuration and/or by including hardware in the processor, e.g., hardware modules, to perform the recited steps and/or control processor configuration. Accordingly, some but not all embodiments are directed to a microphone device, e.g., wireless microphone receiver and/or wireless microphone transmitter, with a processor which includes a module corresponding to each of the steps of the various described methods performed by the device in which the processor is included. In some but not all embodiments a microphone device, e.g., wireless microphone receiver and/or wireless microphone transmitter, includes a module corresponding to each of the steps of the various described methods performed by the device in which the processor is included. The modules may be implemented using software and/or hardware.

Some embodiments are directed to a computer program product comprising a computer-readable medium, e.g., a non-transitory computer-readable medium, comprising code for causing a computer, or multiple computers, to implement various functions, steps, acts and/or operations, e.g. one or more steps described above. Depending on the embodiment, the computer program product can, and sometimes does, include different code for each step to be performed. Thus, the computer program product may, and sometimes does, include code for each individual step of a method, e.g., a method of operating a wireless microphone receiver and/or a wireless microphone transmitter. The code may be in the form of machine, e.g., computer, executable instructions stored on a computer-readable medium such as a RAM (Random Access Memory), ROM (Read Only Memory) or other type of storage device. In addition to being directed to a computer program product, some embodiments are directed to a processor configured to implement one or more of the various functions, steps, acts and/or operations of one or more methods described above. Accordingly, some embodiments are directed to a processor, e.g., CPU, configured to implement some or all of the steps of the methods described herein. The processor may be for use in, e.g., a wireless microphone receiver, a wireless microphone transmitter or other device described in the present application.

While described in the context of an OFDM system, at least some of the methods and apparatus of various embodiments are applicable to a wide range of communications systems including many non-OFDM and/or non-cellular systems.

Numerous additional variations on the methods and apparatus of the various embodiments described above will be apparent to those skilled in the art in view of the above description. Such variations are to be considered within the scope. The methods and apparatus may be, and in various embodiments are, used with CDMA, orthogonal frequency division multiplexing (OFDM), and/or various other types of communications techniques which may be used to provide wireless communications links between the microphone devices. In some embodiments, a wireless microphone receiver is implemented as a stationary device and communicates with microphone transmitters using OFDM and/or CDMA and may provide connectivity to a recording system, an amplification system, a processing, e.g., filtering system, and/or an output system, e.g., a speaker system. In various embodiments the microphone devices are implemented as portable devices including receiver/transmitter circuits and logic and/or routines, for implementing the methods.

What is claimed is:

1. A method of operating a wireless microphone receiver comprising:
scanning a frequency band to be used for wireless microphone communications to detect available communications channels, said available communications channels including a first communications channel; and
transmitting a first channel assignment signal to a first wireless microphone assigning the first communications channel to said first wireless microphone.

2. The method of claim 1, wherein said scanning includes scanning wireless microphone channels to determine if a wireless microphone channel is currently in use by another wireless microphone; and
wherein said first communications channel is a wireless microphone channel on which no wireless microphone signals were detected by said scanning

3. The method of claim 1, further comprising:
repeating said scanning of said frequency band to detect available communications channels; and
transmitting a second channel assignment signal to said first wireless microphone to control said first wireless microphone to use a second communications channel in place of said first communications channel, said second communications channel having better channel quality than said first communications channel.

4. The method of claim 3, further comprising:
transmitting a third channel assignment signal assigning a third communication channel, determined to be available by said scanning, to a second wireless microphone.

5. The method of claim 1, further comprising:
receiving battery status information from said first wireless microphone indicating remaining battery power; and
making a channel assignment for said first wireless microphone based on said battery status information and information indicating channel quality of a plurality of available communications channels.

6. The method of claim 1,
wherein signals from said wireless microphone receiver to wireless microphones are transmitted at a predetermined fixed transmission power level, the method further comprising:
transmitting unicast transmission power control commands to said first wireless microphone and a second wireless microphone to individually control the transmission power level of audio signals transmitted by said first and second wireless microphones, said unicast transmission power control commands including a first transmission power control command directed to the first wireless microphone and a second transmission power control command directed to the second wireless microphone, the first transmission power control command being a function of a received signal power of a signal received from said first wireless microphone and the second transmission power control command being a function of a received signal power of a signal received from the second wireless microphone.

7. A wireless microphone receiver comprising:
means for scanning a frequency band to be used for wireless microphone communications to detect available communications channels, said available communications channels including a first communications channel; and
means for transmitting a first channel assignment signal to a first wireless microphone assigning the first communications channel to said first wireless microphone.

8. The wireless microphone receiver of claim 7, wherein said means for scanning include means for scanning wireless microphone channels to determine if a wireless microphone channel is currently in use by another wireless microphone; and
wherein said first communications channel is a wireless microphone channel on which no wireless microphone signals were detected by said scanning

9. The wireless microphone receiver of claim 7, further comprising:
means for controlling said means for scanning a frequency band to repeat said scanning of said frequency band to detect available communications channels; and
means for transmitting a second channel assignment signal to said first wireless microphone to control said first wireless microphone to use a second communications channel in place of said first communications channel, said second communications channel having better channel quality than said first communications channel.

10. The wireless microphone receiver of claim 9, further comprising:
means for transmitting a third channel assignment signal assigning a third communication channel, determined to be available by said scanning, to a second wireless microphone.

11. The wireless microphone receiver of claim 7, wherein signals from said wireless microphone receiver to wireless microphones are transmitted at a predetermined fixed transmission power level; and
wherein the wireless microphone receiver further comprises means for transmitting unicast transmission power control commands to said first wireless microphone and a second wireless microphone to individually control the transmission power level of audio signals transmitted by said first and second wireless microphones, said unicast transmission power control commands including a first transmission power control command directed to the first wireless microphone and a second transmission power control command directed to the second wireless microphone, the first transmission power control command being a function of a received signal power of a signal received from said first wireless microphone and the second transmission power control command being a function of a received signal power of a signal received from the second wireless microphone.

12. A wireless microphone receiver comprising:
at least one processor configured to:
scan a frequency band to be used for wireless microphone communications to detect available communications channels, said available communications channels including a first communications channel; and
transmit a first channel assignment signal to a first wireless microphone assigning the first communications channel to said first wireless microphone; and
a memory coupled to said at least one processor.

13. The wireless microphone receiver of claim 12, wherein said at least one processor is further configured to scan wireless microphone channels, as part of scanning a frequency band to be used for wireless microphone communications, to determine if a wireless microphone channel is currently in use by another wireless microphone; and
wherein said first communications channel is a wireless microphone channel on which no wireless microphone signals were detected by said scanning

14. The wireless microphone receiver of claim 12, wherein said at least one processor is further configured to:
repeat said scanning of said frequency band to detect available communications channels; and
transmit a second channel assignment signal to said first wireless microphone to control said first wireless microphone to use a second communications channel in place of said first communications channel, said second communications channel having better channel quality than said first communications channel.

15. A computer program product for use in a wireless microphone receiver, the computer program product comprising:
a non-transitory computer readable medium comprising:
code for causing at least one computer to scan a frequency band to be used for wireless microphone communications to detect available communications channels, said available communications channels including a first communications channel; and
code for causing the at least one computer to transmit a first channel assignment signal to a first wireless microphone assigning the first communications channel to said first wireless microphone.

16. A method of operating a wireless microphone receiver, comprising:
transmitting a unicast power control command to a first wireless microphone, said power control command controlling a transmit power of said first wireless microphone; and
receiving audio data from the first wireless microphone, said audio data being transmitted at a power level determined from said power control command.

17. The method of claim 16, further comprising:
detecting communications errors in at least one signal transmitted by said first wireless transmitter; and
wherein said transmitted power control command is a signal instructing the first wireless transmitter to increase its transmit power when the communications errors detected in a period of time exceed a first error threshold.

18. The method of claim 16, wherein said transmitted power control command is a signal instructing the first wireless microphone to increase its transmit power when a signal to noise level for the at least one signal received from said first wireless microphone is below a target SNR threshold.

19. The method of claim 16,
wherein said transmitted power control command is a signal instructing the first wireless microphone to reduce its transmit power when a signal to noise level for the at least one signal received from said first wireless microphone exceeds a target SNR threshold by at least a predetermined amount.

20. The method of claim 16, further comprising:
making a decision, based on a signal received from a second wireless microphone, whether a transmit power of the second wireless microphone should be increased, decreased or remain the same; and
transmitting a second unicast power control command to the second wireless microphone, said second unicast power control command controlling the transmit power of the second wireless microphone, said second unicast power control command communicating whether transmit power of the second wireless microphone should be increased or decreased, said unicast power control command being a function of the decision whether the transmit power of the second wireless microphone should be increased, decreased or remain the same.

21. The method of claim 16,
wherein power control signals transmitted by said wireless microphone receiver to wireless microphones are transmitted at a predetermined fixed transmission power level; and
wherein said wireless microphones transmit audio data to said wireless microphone receiver but do not receive audio data from said wireless microphone receiver.

22. A wireless microphone receiver, comprising:
means for transmitting a unicast power control command to a first wireless microphone, said power control command controlling a transmit power of said first wireless microphone; and
means for receiving audio data from the first wireless microphone, said audio data being transmitted at a power level determined from said power control command.

23. The wireless microphone receiver of claim 22, further comprising:
means for detecting communications errors in at least one signal transmitted by said first wireless transmitter; and
wherein said transmitted power control command is a signal instructing the first wireless transmitter to increase its transmit power when the communications errors detected in a period of time exceed a first error threshold.

24. The wireless microphone receiver of claim 22,
wherein said power control command is a signal instructing the first wireless microphone to increase its transmit power when a signal to noise level for the at least one signal received from said first wireless microphone is below a target SNR threshold.

25. The wireless microphone receiver of claim 22,
wherein said power control command is a signal instructing the first wireless microphone to reduce its transmit power when a signal to noise level for the at least one signal received from said first wireless microphone exceeds a target SNR threshold by at least a predetermined amount.

26. The wireless microphone receiver of claim 22, further comprising:
means for making a decision, based on a signal received from a second wireless microphone, whether a transmit power of the second wireless microphone should be increased, decreased or remain the same; and
means for transmitting a second unicast power control command to the second wireless microphone, said second unicast power control command controlling the transmit power of the second wireless microphone, said second unicast power control command communicating whether transmit power of the second wireless microphone should be increased or decreased, said second unicast power control command being transmitted in response to making a decision that the transmit power of the second wireless microphone should be increased, or decreased.

27. A wireless microphone receiver, comprising:
at least one processor configured to:
transmit a unicast power control command to a first wireless microphone, said power control command controlling a transmit power of said first wireless microphone; and
receive audio data from the first wireless microphone, said audio data being transmitted at a power level determined from said power control command; and
a memory coupled to said at least one processor.

28. The wireless microphone receiver of claim 27, wherein said at least processor is further configured to detect communications errors in at least one signal transmitted by said first wireless transmitter; and
wherein said transmitted power control command is a signal instructing the first wireless transmitter to increase its transmit power when the communications errors detected in a period of time exceed a first error threshold.

29. The wireless microphone receiver of claim 27,
wherein said transmitted power control command is a signal instructing the first wireless microphone to increase its transmit power when a signal to noise level for the at least one signal received from said first wireless microphone is below a target SNR threshold.

30. A computer program product for use in a wireless microphone receiver, the computer program product comprising:
a non-transitory computer readable medium comprising:
code for causing at least one computer to transmit a unicast power control command to a first wireless microphone, said power control command controlling a transmit power of said first wireless microphone; and
code for causing at the least one computer to receive audio data from the first wireless microphone, said audio data being transmitted at a power level determined from said power control command.
